(19) United States
(12) Patent Application Publication
(10) Pub. No.: US 2002/0126068 A1
(43) Pub. Date: Sep. 12, 2002

(54) Method and apparatus for driving capillary discharge plasma display panel

(75) Inventors: Steven Kim, Harrington Park, NJ (US); Bhum-Jae Shin, Jersey City, NJ (US)

Correspondence Address: MORGAN LEWIS & BOCKIUS LLP, 1111 PENNSYLVANIA AVENUE NW, WASHINGTON, DC, 20004, US

(73) Assignee: Plasmion Displays, LLC.

(21) Appl. No.: 09/987,449

(22) Filed: Nov. 14, 2001

Related U.S. Application Data
(60) Provisional application No. 60/248,006, filed on Nov. 14, 2000.

(51) Int. Cl. G09G 3/28

(52) U.S. Cl. 345/60

(57) ABSTRACT

An apparatus for driving a capillary discharge plasma display panel having first and second substrates spaced apart, a plurality of pairs of first and second electrodes arranged between the first and second substrates, a dielectric layer formed between the first and second electrodes, at least one capillary in the dielectric layer between the each pair of the first and second electrodes for generating a capillary discharge, the apparatus includes a plurality of cells selectively discharging to glow defined by the pairs of the first and second electrodes, and an address circuit for applying a triangular pulse waveform during a sustain period to stabilize the capillary discharge.

This application claims the benefit of a provision application, entitled “Method and Apparatus For Driving Capillary Discharge Plasma Display Pane,” which was filed Nov. 14, 2000, and assigned Provisional Application Number 60/248,006, which is hereby incorporated by reference.

### BACKGROUND OF THE INVENTION

1. Field of the Invention

The present relates to a method and an apparatus for driving a display panel, and more particularly, to a method and an apparatus for driving a capillary discharge plasma display panel.

2. Discussion of the Related Art

A plasma discharge display panel (PDP) is designed to sustain electrical discharge by application of a voltage between two electrodes, thereby providing a display image. During the application of the voltage, three different stages exists: a reset period, an address period, and a sustain period. In conventional driving methods, a relatively small quantity of wall charge remains in every display cell during the reset period. During the address period, an address discharge is generated to accumulate the residual wall charges that will be used as a sustain discharge during the sustain period. Sustain pulses are added to the residual wall discharges to create the sustain discharge only in display cells that have previously caused an address discharge. In the conventional PDP driving method, the sustain pulses are square pulse waveforms.

A capillary discharge plasma display panel (CDPDP) is advantageous over a surface discharge plasma display panel as disclosed in the U.S. Pat. No. 6,255,777 B1, which is hereby incorporated by reference. The CDPDP can produce a higher density plasma as compared to the plasma generated by the surface discharge PDP operating under similar conditions. However, the capillary discharge of the CDPDP may be unstable due to variations in a sustain voltage in each display cell.

Each pixel (or display cell) in a PDP has different voltage characteristics due to a result of fabrication errors. The fabrication errors cause a change in a sustain voltage at each pixel. As shown in FIG. 1, depending on the total number of display cells (i.e., pixels), the sustain voltage for each individual pixel has different minimum and maximum sustain voltage values. A margin exists within the sustain voltage value, and may be expressed by:

Margin=Vs,max−Vs,min (1)

wherein, Vs,max represents a relative maximum sustain voltage value and Vs,min represents a relative minimum sustain voltage value. In order to turn on all the pixels, a voltage applied to the PDP should be at least higher than the relative minimum sustain voltage value (Vs,min). Conversely, if the voltage applied to the PDP is higher than the relative maximum sustain voltage (Vs, max), an excessive voltage may permanently damage the pixel, thereby causing variations in luminance of the display panel.

Unlike a conventional surface discharge, a capillary discharge is not easily controllable using a conventional square pulse waveform during a sustain period. As shown in FIG. 2, an excessive voltage greater than the relative maximum sustain voltage value Vs,max may be generated upon application of a square pulse waveform.

### SUMMARY OF THE INVENTION

Accordingly, the present invention is directed to an apparatus and a method for driving capillary discharge plasma display panel that substantially obviates one or more of the problems due to limitations and disadvantages of the related art.

An object of the present invention is provide an apparatus and method for driving a capillary discharge plasma display panel having a uniform luminance.

Another object of the present invention is to provide an apparatus and method for driving a capillary discharge plasma display panel having a controllable discharge plasma.

Additional features and advantages of the invention will be set forth in the description which follows, and in part will be apparent from the description, or may be learned by practice of the invention. The objective and other advantages of the invention will be realized and attained by the structure particularly pointed out in the written description and claims hereof as well as the appended drawings.

To achieve these and other advantages and in accordance with the purpose of the present invention, as embodied and broadly described, an apparatus for driving a capillary discharge plasma display panel having first and second substrates spaced apart, a plurality of pairs of first and second electrodes arranged between the first and second substrates, a dielectric layer formed between the first and second electrodes, at least one capillary in the dielectric layer between the each pair of the first and second electrodes for generating a capillary discharge, the apparatus includes a plurality of cells selectively discharging to glow defined by the pairs of the first and second electrodes, and an address circuit for applying a triangular pulse waveform during a sustain period to stabilize the capillary discharge.

In another aspect of the present invention, a method for driving a capillary discharge plasma display panel having first and second substrates spaced apart, a plurality of pairs of first and second electrodes arranged between the first and second substrates, a dielectric layer formed between the first and second electrodes, at least one capillary in the dielectric layer between the each pair of the first and second electrodes for generating a capillary discharge, the method includes applying a scan pulse to the plurality of the electrodes during an addressing period, and applying a triangular pulse to the plurality of the electrodes during a sustain period to stabilize the capillary discharge at each cell.

### BRIEF DESCRIPTION OF THE DRAWINGS

The accompanying drawings, which are intended to provide a further understanding of the invention and are incorporated in and constitute a part of this specification, illustrate embodiments of the invention and together with the description serve to explain the principles of the invention. In the drawings:

FIG. 1 illustrates a relationship between relative minimum and maximum sustain voltage values and a number of display cells;

FIG. 2 is a diagram illustrating a square pulse waveform applied to electrodes of a display panel during a sustain period according to a background art driving method;

FIG. 3 is a diagram illustrating an exemplary triangular pulse waveform applied to electrodes of a display panel during a sustain electrode according to a driving method in the present invention;

FIG. 4 is a block diagram illustrating an exemplary capillary discharge plasma display according to the present invention;

FIG. 5 illustrates an exemplary relationship between sustain voltage margin and frequency according to the present invention;

FIG. 6 illustrates an exemplary relationship between luminance and frequency according to the present invention;

FIG. 7 illustrates a cross-sectional view of an exemplary alternating current (AC) capillary display panel according to the present invention; and

FIG. 8 illustrates a cross-sectional view of an exemplary direct current (DC) capillary display panel according to the present invention.

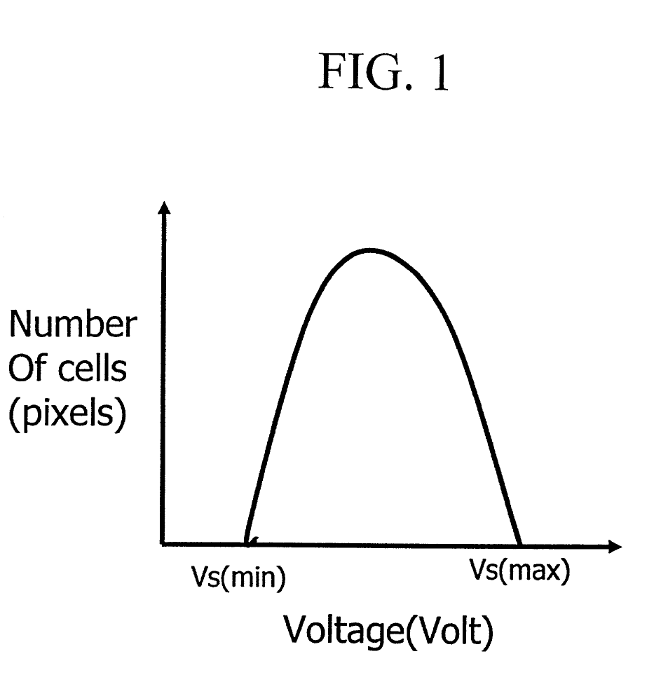

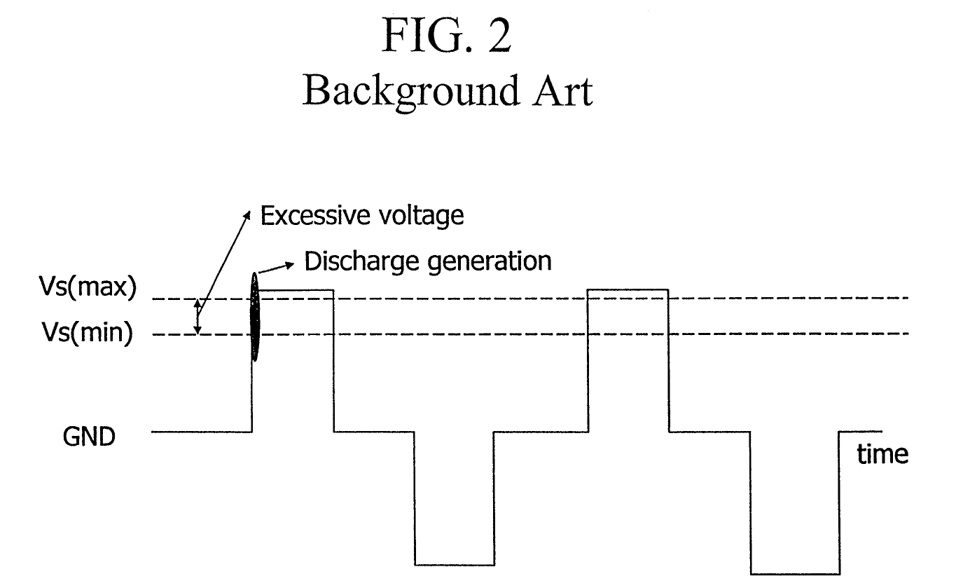

### DETAILED DESCRIPTION OF THE ILLUSTRATED EMBODIMENTS

Reference will now be made in detail to the illustrated embodiments of the present invention, examples of which are illustrated in the accompanying drawings.

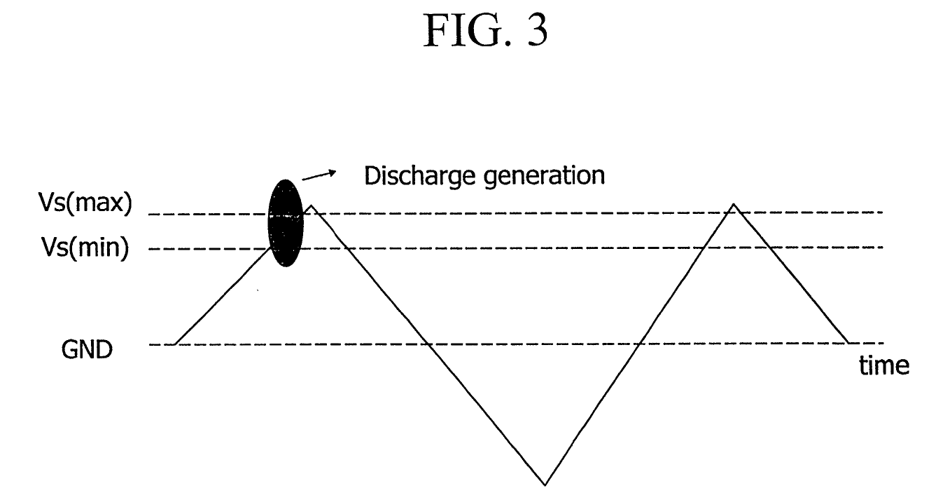

FIG. 3 is a waveform applied to a PDP during a sustain period where ultraviolet (UV) light is converted to visible light by a phosphor layer within the PDP. In FIG. 3, a triangular pulse waveform is applied to electrodes of a display panel during the sustain period, thereby reducing an excessive voltage during a discharge generation.

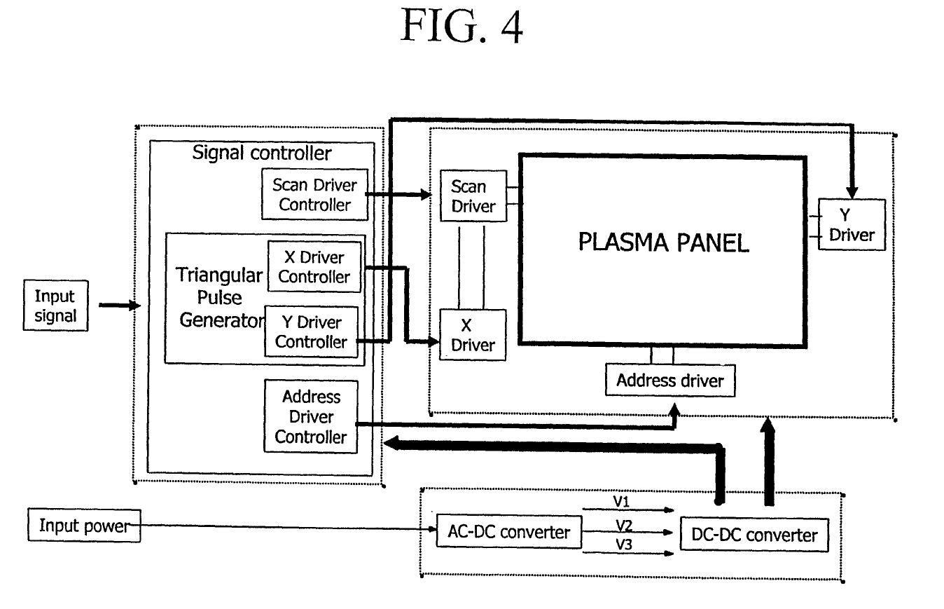

FIG. 4 a block diagram illustrating an exemplary capillary discharge plasma display unit according to the present invention. In FIG. 4, an input signal is applied to a signal controller that includes both an X driver controller and a Y driver controller through a triangular pulse generator during a sustain period. The X and Y driver controllers transmit the triangular pulse waveform to X and Y drivers of the plasma display panel, respectively. The X and Y drivers transmit the triangular pulse waveform to electrodes of the plasma display panel.

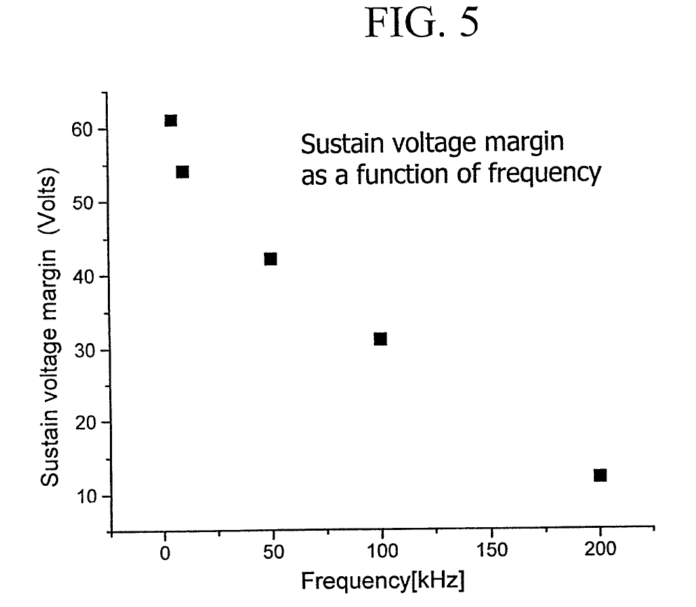

FIG. 5 illustrates a relationship between a sustain voltage margin and an input signal frequency. As shown in FIG. 5, as the frequency of the input signal increases, the sustain voltage margin decreases. Accordingly, a desired sustain voltage margin can be determined based upon the input signal frequency.

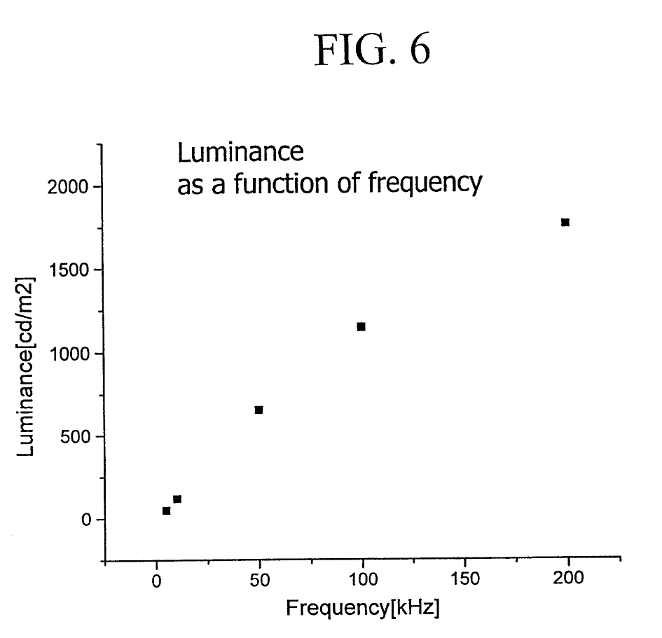

FIG. 6 illustrates a relationship between luminance of a PDP and an input signal frequency. As shown in FIG. 6, as the frequency of the input signal increases, the luminance of the PDP increases. Accordingly, a desired luminance of the PDP can be determined based upon the input signal frequency.

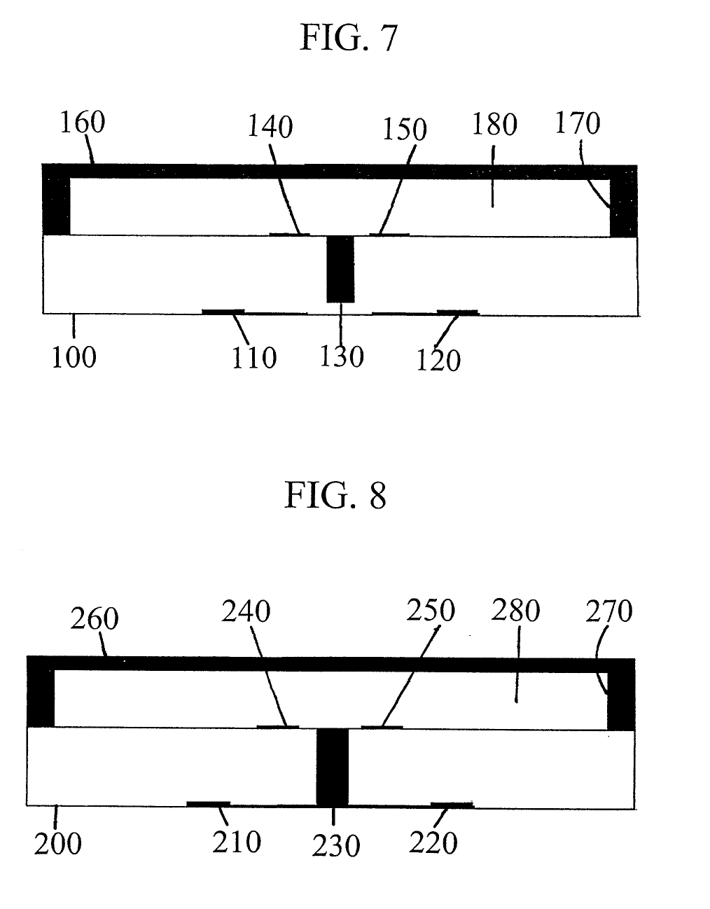

FIG. 7 is a cross-sectional representation of an exemplary AC capillary discharge PDP according to the present invention. In FIG. 7, a transparent dielectric layer 100 is formed on a transparent substrate (not shown). Transparent first and second electrodes 110 and 120 are formed on the transparent substrate (not shown) opposing sides of a capillary hole 130 formed partially through the transparent dielectric layer 100. The transparent first and second electrodes 110 and 120 may be formed of indium-tin-oxide (ITO), for example. Transparent third and fourth electrodes 140 and 150 are disposed on the transparent dielectric layer 100 opposing sides of the capillary hole 130. The transparent third and fourth electrodes 140 and 150 may be formed of indium-tin-oxide (ITO), for example. A phosphor layer 160 and barrier ribs 170 are formed on the transparent dielectric layer 100 to form a discharge plasma chamber 180. An applied voltage to the AC capillary discharge PDP is within a range of about 150V to about 300V.

FIG. 8 is a cross-sectional representation of an exemplary DC capillary discharge PDP according to the present invention. In FIG. 8, a transparent dielectric layer 200 is formed on a transparent substrate (not shown). Transparent first and second electrodes 210 and 220 are formed on the transparent substrate (not shown) opposing sides of a capillary hole 230 formed to extend through the transparent dielectric layer 200. The transparent first and second electrodes 210 and 220 may be formed of indium-tin-oxide (ITO), for example. Transparent third and fourth electrodes 240 and 250 are disposed on the transparent dielectric layer 200 opposing sides of the capillary hole 230. The transparent third and fourth electrodes 240 and 250 may be formed of indium-tin-oxide (ITO), for example. A phosphor layer 260 and barrier ribs 170 are formed on the transparent dielectric layer 200 to create a discharge plasma chamber 280. An applied voltage to the DC capillary discharge PDP is within a range of about 150V to about 300V.

It will be apparent to those skilled in the art that various modifications and variations can be made in the method and apparatus for driving capillary discharge plasma panel of the present invention without departing from the spirit or scope of the invention. Thus, it is intended that the present invention cover the modifications and variations of this invention provided they come within the scope of the appended claims and their equivalents.

What is claimed is:

1. An apparatus for driving a capillary discharge plasma display panel having first and second substrates spaced apart, a plurality of pairs of first and second electrodes arranged between the first and second substrates, a dielectric layer formed between the first and second electrodes, at least one capillary in the dielectric layer between the each pair of the first and second electrodes for generating a capillary discharge, the apparatus comprising:
a plurality of cells selectively discharging to glow defined by the pairs of the first and second electrodes; and
an address circuit for applying a triangular pulse waveform during a sustain period to stabilize the capillary discharge.

2. The apparatus according to claim 1, wherein the at least one capillary extends partially through the dielectric layer.

3. The apparatus according to claim 1, wherein the at least one capillary extends completely through the dielectric layer.

4. The apparatus according to claim 1, wherein the first and second electrodes include indium-tin-oxide.

5. The apparatus according to claim 1, wherein a voltage applied to the first and second electrodes is within a range of about 150V to about 300V.

6. The apparatus according to claim 1, wherein the first and second electrodes are disposed on opposing sides of the at least one capillary.

7. A method for driving a capillary discharge plasma display panel having first and second substrates spaced apart, a plurality of pairs of first and second electrodes arranged between the first and second substrates, a dielectric layer formed between the first and second electrodes, at least one capillary in the dielectric layer between the each pair of the first and second electrodes for generating a capillary discharge, the method comprising:
applying a scan pulse to the plurality of the electrodes during an addressing period; and
applying a triangular pulse to the plurality of the electrodes during a sustain period to stabilize the capillary discharge at each cell.

8. The apparatus according to claim 7, wherein the at least one capillary extends partially through the dielectric layer.

9. The apparatus according to claim 7, wherein the at least one capillary extends completely through the dielectric layer.

10. The apparatus according to claim 7, wherein the first and second electrodes include indium-tin-oxide.

11. The apparatus according to claim 7, wherein a voltage applied to the first and second electrodes is within a range of about 150V to about 300V.

12. The apparatus according to claim 7, wherein the first and second electrodes are disposed on opposing sides of the at least one capillary.
